(19) United States
(12) Patent Application Publication
(10) Pub. No.: US 2015/0147481 A1
(43) Pub. Date: May 28, 2015

(54) METHOD FOR MAKING A SCISSORING-TYPE CURRENT-PERPENDICULAR-TO-THE-PLANE (CPP) MAGNETORESISTIVE SENSOR WITH EXCHANGE-COUPLED SOFT SIDE SHIELDS

(71) Applicant: HGST Nertherlands B..V., Amsterdam (NL)

(72) Inventors: Patrick Mesquita Braganca, San Jose, CA (US); Jordan Asher Katine, Mountain View, CA (US); Neil Smith, San Jose, CA (US)

(73) Assignee: HGST Nertherlands B..V., Amsterdam (NL)

(21) Appl. No.: 14/085,593

(22) Filed: Nov. 20, 2013

(51) Int. Cl. G11B 5/39; C25D 7/00; C25D 5/48

(52) U.S. Cl. CPC G11B 5/39; C25D 5/48; C25D 7/001
USPC 427/529; 427/130; 427/548; 427/523; 205/191

(57) ABSTRACT

A method for making a scissoring type current-perpendicular-to-the-plane magnetoresistive sensor with exchange-coupled soft side shields uses oblique angle ion milling to remove unwanted material from the side edges of the upper free layer. All of the layers making up the sensor stack are deposited as full films. The sensor stack is then ion milled to define the sensor side edges. The side regions are then refilled by deposition of an insulating layer. Next, the lower soft magnetic layers of the exchange-coupled side shields are deposited, which also coats the insulating layer up to and past the side edges of the upper free layer. The soft magnetic material adjacent the side edges of the upper free layer is removed by oblique angle ion beam milling. The material for the antiparallel-coupling (APC) layers is deposited, followed by deposition of the material for the upper soft magnetic layers of the exchange-coupled side shields.

### BACKGROUND OF THE INVENTION

1. Field of the Invention

The invention relates generally to a current-perpendicular-to-the-plane (CPP) magnetoresistive (MR) sensor that operates with the sense current directed perpendicularly to the planes of the layers making up the sensor stack, and more particularly to a scissoring-type CPP sensor with dual sensing or free layers.

2. Background of the Invention

One type of conventional MR sensor used as the read head in magnetic recording disk drives is a “spin-valve” sensor based on the giant magnetoresistance (GMR) effect. A GMR spin-valve sensor has a stack of layers that includes two ferromagnetic layers separated by a nonmagnetic electrically conductive spacer layer, which is typically copper (Cu) or silver (Ag). One ferromagnetic layer adjacent the spacer layer has its magnetization direction fixed, such as by being pinned by exchange coupling with an adjacent antiferromagnetic layer, and is referred to as the reference layer. The other ferromagnetic layer adjacent the spacer layer has its magnetization direction free to rotate in the presence of an external magnetic field and is referred to as the free layer. With a sense current applied to the sensor, the rotation of the free-layer magnetization relative to the reference-layer magnetization due to the presence of an external magnetic field is detectable as a change in electrical resistance. If the sense current is directed perpendicularly through the planes of the layers in the sensor stack, the sensor is referred to as a current-perpendicular-to-the-plane (CPP) sensor.

In addition to CPP-GMR read heads, another type of CPP-MR sensor is a magnetic tunnel junction sensor, also called a tunneling MR or TMR sensor, in which the nonmagnetic spacer layer is a very thin nonmagnetic tunnel barrier layer. In a CPP-TMR sensor the tunneling current perpendicularly through the layers depends on the relative orientation of the magnetizations in the two ferromagnetic layers. In a CPP-GMR read head the nonmagnetic spacer layer is formed of an electrically conductive material, typically a metal such as Cu or Ag. In a CPP-TMR read head the nonmagnetic spacer layer is formed of an electrically insulating material, such as TiO₂, MgO, or Al₂O₃.

A type of CPP sensor has been proposed that does not have a ferromagnetic reference layer with a fixed or pinned magnetization direction, but instead has dual ferromagnetic sensing or free layers separated by a nonmagnetic spacer layer. In the absence of an applied magnetic field, the magnetization directions or vectors of the two free layers are oriented generally orthogonal to one another with parallel magnetization components in the sensing direction of the magnetic field to be detected and antiparallel components in the orthogonal direction. With a sense current applied perpendicularly to the layers in the sensor stack and in the presence of an applied magnetic field in the sensing direction, the two magnetization vectors rotate in opposite directions, changing their angle relative to one another, which is detectable as a change in electrical resistance. Because of this type of behavior of the magnetization directions of the two free layers, this type of CPP sensor will be referred to herein as a “scissoring-type” of CPP sensor. If a CPP-GMR scissoring-type sensor is desired the nonmagnetic spacer layer is an electrically conducting metal or metal alloy. If a CPP-TMR scissoring-type sensor is desired the spacer layer is an electrically insulating material. In a scissoring-type CPP-MR sensor, a “hard-bias” layer of ferromagnetic material located at the back edge of the sensor (opposite the air-bearing surface) applies an approximately fixed, transverse magnetic “bias” field to the sensor. Its purpose is to bias the magnetization directions of the two free layers so that they are approximately orthogonal to one another in the quiescent state, i.e., in the absence of an applied magnetic field. Without the hard bias layer, the magnetization directions of the two free layers would tend to be oriented antiparallel to one another. This tendency to be oriented antiparallel results from strong magnetostatic interaction between the two free layers once they have been patterned to sensor dimensions, but may also be the result of exchange coupling between the magnetic layers through the spacer layer. A scissoring-type of CPP-MR sensor is described in U.S. Pat. No. 7,035,062 B2. Unlike in a conventional CPP GMR or TMR sensor, in a scissoring-type CPP-MR sensor there is no need for an antiferromagnetic pinning layer. Accordingly, the read-gap and parasitic series electrical resistances are greatly reduced. This enables an enhanced down-track resolution and a stronger magnetoresistance signal.

While the hard bias field at the sensor back edge will tend to align the magnetization directions of the two free layers in a CPP-MR sensor generally orthogonal relative to one another, there is no preference for the specific directions of the two free layer magnetizations in the quiescent state. Thus it is just as likely that a free layer magnetization direction may point in a direction at 45 degrees relative to the hard bias magnetization direction as at 135 degrees. For this reason longitudinal side biasing of the two free layers will stabilize the magnetization directions in one of these two possible orientations in the quiescent state.

What is needed is a method for making a scissoring-type CPP-MR sensor with side shields to improve the stability of the magnetization directions of the two free layers.

### SUMMARY OF THE INVENTION

Embodiments of this invention relate to methods for making a scissoring type CPP-MR sensor with exchange-coupled soft side shields. The soft side shields prevent reading of recorded bits in tracks adjacent the track being read and also bias the magnetization directions of the two free layers (FL1 and FL2) longitudinally so they have a preferred direction antiparallel to one another in the quiescent state. First, all of the layers making up the sensor stack are deposited as full films on the bottom along-the-track shield (S1). A layer of photoresist is then lithographically patterned to define two side edges of the sensor, and the sensor stack is ion milled to remove the layers outside the sensor side edges down to S1. This results in a sloping tail at the base of the milled stack. The side regions are then refilled by deposition of an insulating layer, typically alumina or a silicon nitride (SiNx), on S1 and on the side edges. Next, the lower soft magnetic layers of the exchange-coupled side shields for biasing FL1 are deposited by ion beam deposition, which also coats the insulating layer up to and past the side edges of FL2. The material of the lower soft magnetic layers adjacent the side edges of FL2 is then removed by oblique angle ion beam milling, preferably at an angle between 50 and 85 degrees from a normal to S1. This cleans the insulating layer of the soft magnetic material on the vertical edges of the sensor without significant damage to or removal of the main body of the lower soft magnetic layers. Next, the material for the antiparallel-coupling (APC) layers for the exchange-coupled side shields is deposited, followed by deposition of the material for the upper soft magnetic layers of the exchange-coupled side shields for biasing FL2. The upper layers of the exchange-coupled side shields may then be exchange-coupled to the upper along-the-track magnetic shield S2.

For a fuller understanding of the nature and advantages of the present invention, reference should be made to the following detailed description taken together with the accompanying figures.

### BRIEF DESCRIPTION OF THE DRAWINGS

FIG. 1 is a schematic top view of a conventional magnetic recording hard disk drive with the cover removed.

FIG. 2 is an enlarged end view of the slider and a section of the disk taken in the direction 2-2 in FIG. 1.

FIG. 3 is a view in the direction 3-3 of FIG. 2 and shows the ends of the read/write head as viewed from the disk.

FIG. 4A is a cross-sectional schematic view facing the air-bearing surface (ABS) of the scissoring-mode CPP-MR read head according to the prior art and showing the stack of layers located between the magnetic shield layers.

FIG. 4B is a view of section 4B-4B of FIG. 4A and shows the ABS in edge view and the hard biasing layer recessed from the ABS.

FIG. 4C is a top view of the plane of section 4C-4C of FIG. 4B and shows the ABS in edge view and the hard biasing layer recessed from the ABS.

FIG. 5A is a sectional view facing the ABS of a CPP-MR sensor with exchange-coupled soft side shields.

FIG. 5B is a top view of the plane of section 5B-5B of FIG. 5A.

FIGS. 6A-6D are sectional views facing the ABS and illustrating steps in the method for forming the exchange-coupled side shields in the CPP-MR read head shown in FIGS. 5A-5B.

FIG. 7 is a sectional view showing the exchange coupling of the upper soft side shield layers with the top shield S2.

### DETAILED DESCRIPTION OF THE INVENTION

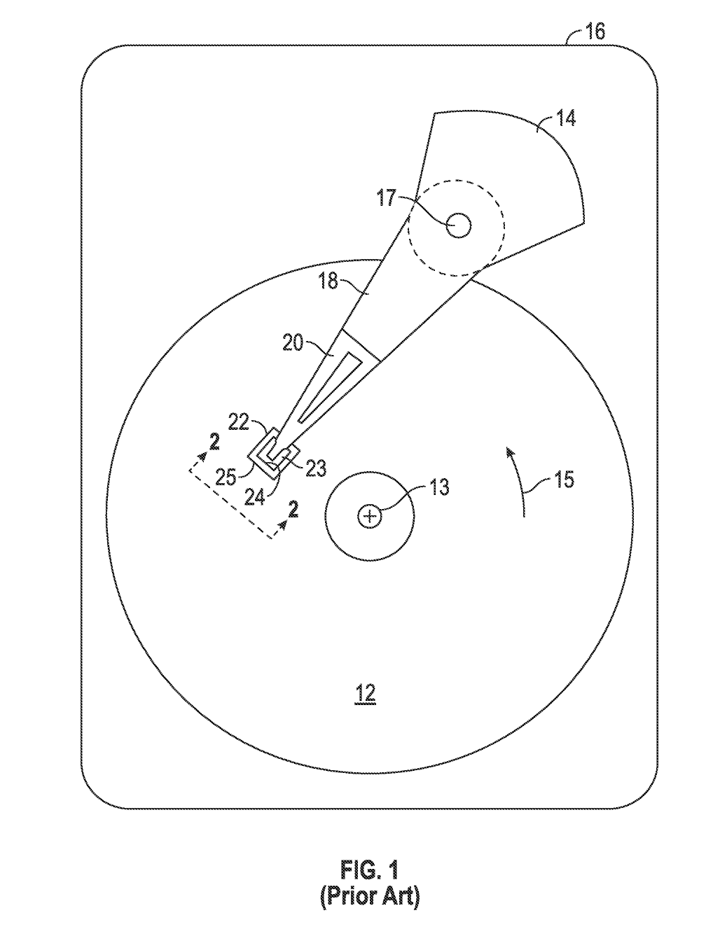

The scissoring-type CPP magnetoresistive (MR) sensor of this invention has application for use in a magnetic recording disk drive, the operation of which will be briefly described with reference to FIGS. 1-3. FIG. 1 is a block diagram of a conventional magnetic recording hard disk drive. The disk drive includes a magnetic recording disk 12 and a rotary voice coil motor (VCM) actuator 14 supported on a disk drive housing or base 16. The disk 12 has a center of rotation 13 and is rotated in direction 15 by a spindle motor (not shown) mounted to base 16. The actuator 14 pivots about axis 17 and includes a rigid actuator arm 18. A generally flexible suspension 20 includes a flexure element 23 and is attached to the end of arm 18. A head carrier or air-bearing slider 22 is attached to the flexure 23. A magnetic recording read/write head 24 is formed on the trailing surface 25 of slider 22. The flexure 23 and suspension 20 enable the slider to “pitch” and “roll” on an air-bearing generated by the rotating disk 12. Typically, there are multiple disks stacked on a hub that is rotated by the spindle motor, with a separate slider and read/write head associated with each disk surface.

FIG. 2 is an enlarged end view of the slider 22 and a section of the disk 12 taken in the direction 2-2 in FIG. 1. The slider 22 is attached to flexure 23 and has an air-bearing surface (ABS) 27 facing the disk 12 and a trailing surface 25 generally perpendicular to the ABS. The ABS 27 causes the airflow from the rotating disk 12 to generate a bearing of air that supports the slider 20 in very close proximity to or near contact with the surface of disk 12. The read/write head 24 is formed on the trailing surface 25 and is connected to the disk drive read/write electronics by electrical connection to terminal pads 29 on the trailing surface 25. As shown in the sectional view of FIG. 2, the disk 12 is a patterned-media disk with discrete data tracks 50 spaced-apart in the cross-track direction, one of which is shown as being aligned with read/write head 24. The discrete data tracks 50 have a track width TW in the cross-track direction and may be formed of continuous magnetizable material in the circumferential direction, in which case the patterned-media disk 12 is referred to as a discrete-track-media (DTM) disk. Alternatively, the data tracks 50 may contain discrete data islands spaced-apart along the tracks, in which case the patterned-media disk 12 is referred to as a bit-patterned-media (BPM) disk. The disk 12 may also be a conventional continuous-media (CM) disk wherein the recording layer is not patterned, but is a continuous layer of recording material. In a CM disk the concentric data tracks with track width TW are created when the write head writes on the continuous recording layer.

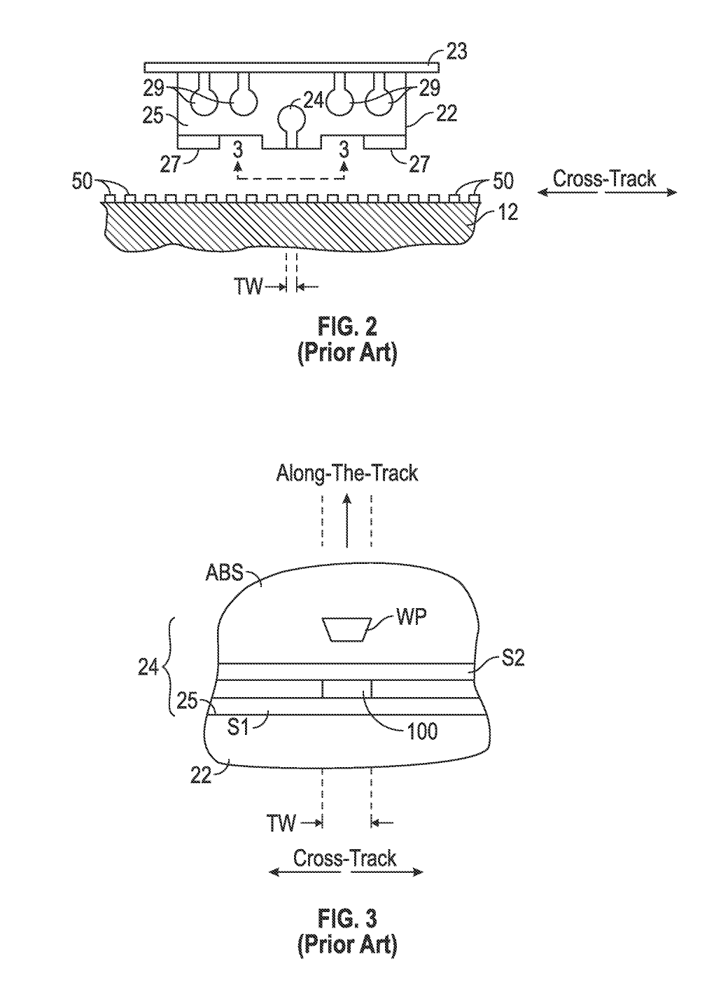

FIG. 3 is a view in the direction 3-3 of FIG. 2 and shows the ends of read/write head 24 as viewed from the disk 12. The read/write head 24 is a series of thin films deposited and lithographically patterned on the trailing surface 25 of slider 22. The write head includes a perpendicular magnetic write pole (WP) and may also include trailing and/or side shields (not shown). The scissoring-type CPP MR sensor or read head 100 is located between two magnetic shields S1 and S2. The shields S1, S2 are formed of magnetically permeable material, typically a NiFe alloy, and may also be electrically conductive so they can function as the electrical leads to the read head 100. The shields function to shield the read head 100 from recorded data bits that are neighboring the data bit being read. Separate electrical leads may also be used, in which case the read head 100 is formed in contact with layers of electrically conducting lead material, such as ruthenium, tantalum, gold, or copper, that are in contact with the shields S1, S2. FIG. 3 is not to scale because of the difficulty in showing very small dimensions. Typically each shield S1, S2 is several microns thick in the along-the-track direction, as compared to the total thickness of the read head 100 in the along-the-track direction, which may be in the range of 20 to 40 nm.

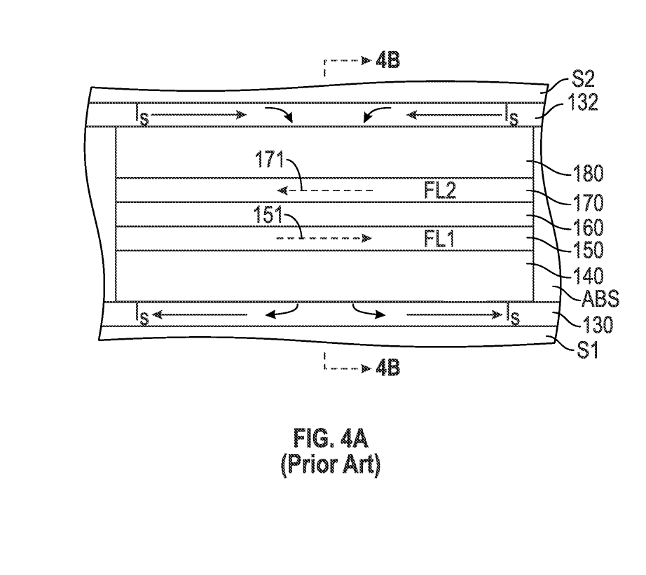

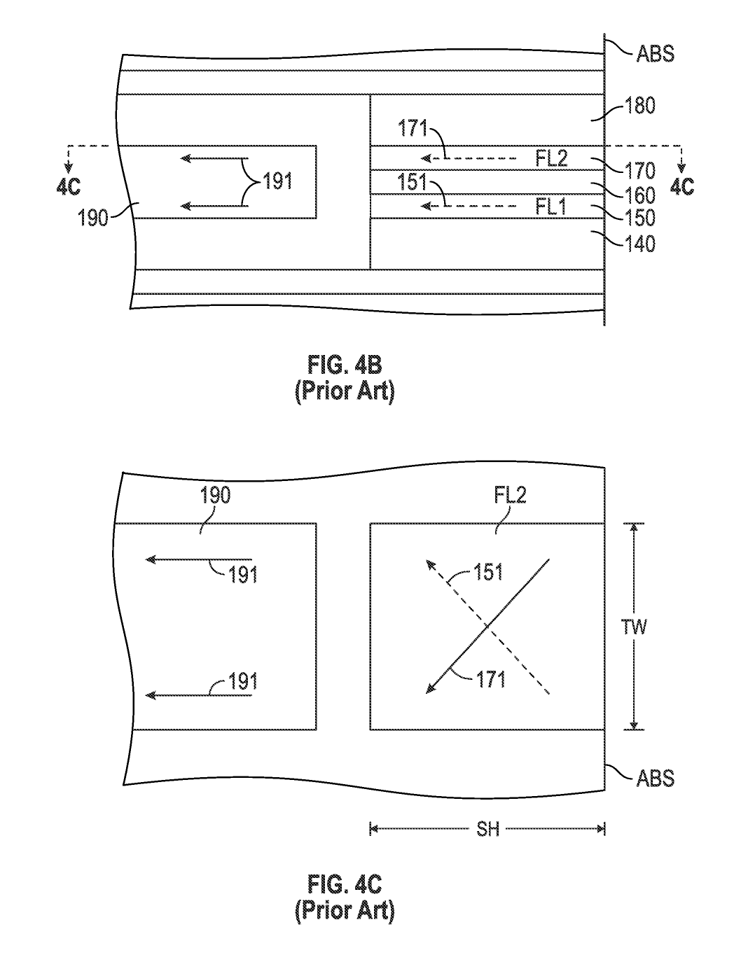

FIG. 4A is an enlarged sectional view facing the ABS of a prior art scissoring-type CPP GMR or TMR read head comprising a stack of layers, including dual sensing or free layers, formed between the two magnetic shield layers S1, S2. S1 and S2 are typically electroplated NiFe alloy films. The lower shield 51 is typically polished by chemical-mechanical polishing (CMP) to provide a smooth substrate for the growth of the sensor stack. This may leave an oxide coating which can be removed with a mild etch just prior to sensor deposition. The sensor layers are a first ferromagnetic free or sensing layer (FL1) 150 having a magnetic moment or magnetization direction 151 and a second ferromagnetic free or sensing layer (FL2) 170 having a magnetic moment or magnetization direction 171.

FL1 and FL2 are typically formed of conventional ferromagnetic materials like crystalline CoFe or NiFe alloys, or a multilayer of these materials, such as a CoFe/NiFe bilayer. Instead of these conventional ferromagnetic materials, FL1 and FL2 may be formed of or comprise a ferromagnetic Heusler alloy, some of which are known to exhibit high spin-polarization in their bulk form. Examples of Heusler alloys include but are not limited to the full Heusler alloys Co₂MnX (where X is one or more of Al, Sb, Si, Sn, Ga, or Ge). Examples also include but are not limited to the half Heusler alloys NiMnSb, PtMnSb, and Co₂FexCr₍₁₋ₓ₎Al (where x is between 0 and 1).

FL1 and FL2 comprise self-referenced free layers, and hence no pinned or pinning layers are required, unlike in conventional CPP spin-valve type sensors. FL1 and FL2 have their magnetization directions 151, 171, respectively, oriented in-plane and preferably generally orthogonal to one another in the absence of an applied magnetic field. While the magnetic moments 151, 171 in the quiescent state (the absence of an applied magnetic field) are preferably oriented generally orthogonal, i.e., between about 70 and 90 degrees to each other, they may be oriented by less than generally orthogonal, depending on the bias point at which the sensor 100 is operated. FL1 and FL2 are separated by a nonmagnetic spacer layer 160. Spacer layer 160 is a nonmagnetic electrically conductive metal or metal alloy, like Cu, Au, Ag, Ru, Rh, Cr and their alloys, if the sensor 100 is a CPP GMR sensor, and a nonmagnetic insulating material, like TiO₂, MgO or Al₂O₃, if the sensor 100 is a CPP TMR sensor.

Located between the lower shield layer S1 and the FL1 are the bottom electrical lead 130 and an underlayer or seed layer 140. The seed layer 140 may be a single layer or multiple layers of different materials. Located between FL2 and the upper shield layer S2 are a capping layer 180 and the top electrical lead 132. The leads 130, 132 are typically Ta or Rh, with lead 130 serving as the substrate for the sensor stack. However, a lower resistance material may also be used. They are optional and used to adjust the shield-to-shield spacing. If the leads 130 and 132 are not present, the bottom and top shields S1 and S2 are used as leads, with S1 then serving as the substrate for the deposition of the sensor stack. The underlayer or seed layer 140 is typically one or more layers of NiFeCr, NiFe, Ta, Cu or Ru. The capping layer 180 provides corrosion protection and is typically formed of single layers, like Ru or Ta, or multiple layers of different materials, such as a Cu/Ru/Ta trilayer.

In the presence of an external magnetic field in the range of interest, i.e., magnetic fields from recorded data on the disk 12, the magnetization directions 151 and 171 of FL1 and FL2, respectively, will rotate in opposite directions. Thus when a sense current Iₛ is applied from top lead 132 perpendicularly through the stack to bottom lead 130, the magnetic fields from the recorded data on the disk will cause rotation of the magnetizations 151, 171 in opposite directions relative to one another, which is detectable as a change in electrical resistance.

FIG. 4B is a sectional view along the plane 4B-4B in FIG. 4A and shows the ABS as a plane normal to the paper. FIG. 4C is a view along the plane 4C-4C in FIG. 4B with the ABS as a plane normal to the paper and shows the trackwidth (TW) and stripe height (SH) dimensions of the sensor. FIG. 4C shows the in-plane generally orthogonal relative orientation of magnetization directions 151, 171, with magnetization direction 151 being depicted as a dashed arrow because it is the magnetization direction of underlying FL1 which is not visible in FIG. 4C. As can be seen from FIG. 4C, in the absence of an applied magnetic field, the magnetization directions or vectors 151, 171 have parallel components in the sensing direction of the magnetic field to be detected (perpendicular to the ABS) and antiparallel components in the orthogonal direction (parallel to the ABS). FIGS. 4B and 4C show a hard bias layer 190 recessed from the ABS. The hard bias layer 190 is magnetized in-plane in the direction 191. Hard bias layer 190 stabilizes or biases the FL1, FL2 magnetization directions 151, 171 so they make a non-zero angle relative to one another, preferably a generally orthogonal relative orientation, by rotating them away from what would otherwise be an antiparallel orientation. Referring to FIG. 4C, the detected signal field is generally perpendicular to the ABS and is aligned generally collinearly with the bias field 191 from the hard bias layer 190.

While the hard bias field 191 at the sensor back edge will tend to align the magnetization directions 151, 171 of the two free layers FL1, FL2 generally orthogonal relative to one another, there is no preference for the specific directions of the magnetizations 151, 171. For example, referring to FIG. 4C, while FL1 magnetization direction 151 is depicted as pointing approximately −45 degrees (counter clockwise) relative to the ABS, with FL2 magnetization direction 171 pointing approximately +45 degrees (clockwise) relative to the ABS, it is just as likely that these two magnetization directions could be switched (i.e., magnetization direction 151 could be at +45 degrees clockwise with magnetization direction 171 at −45 degrees counter clockwise).

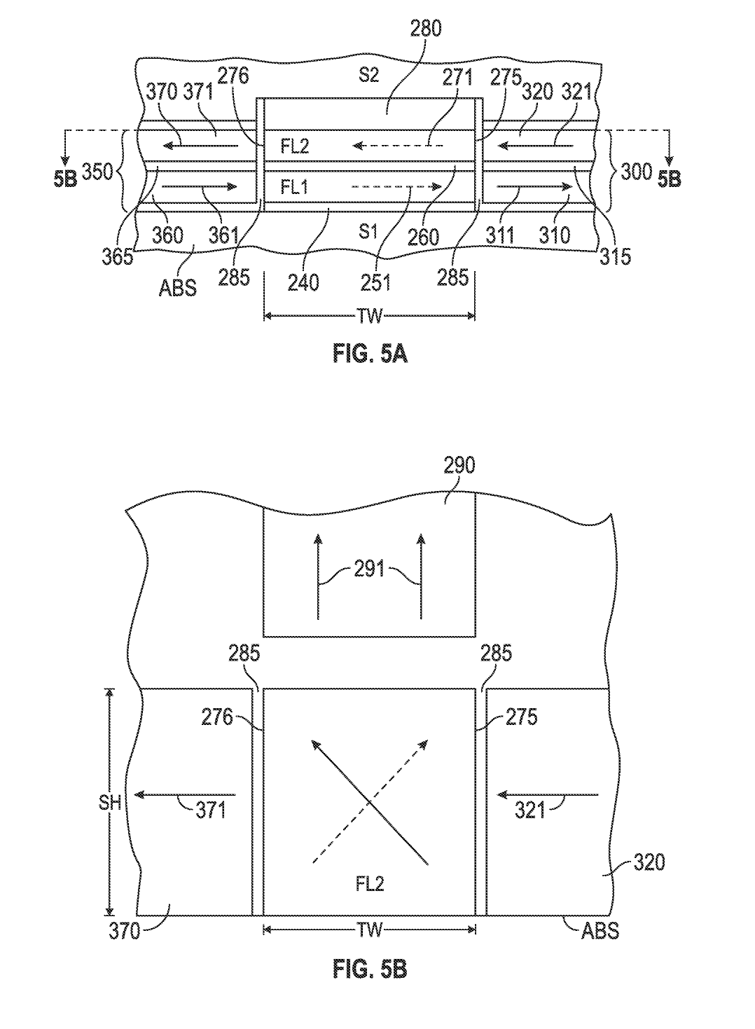

Embodiments of this invention relate to methods for making a scissoring type CPP MR sensor with exchange-coupled soft side shields, like that depicted in FIGS. 5A-5B. The soft side shields prevent reading of recorded bits in tracks adjacent the track being read and also bias the FL 1 and FL2 magnetization directions longitudinally so they have a preferred direction in the quiescent state. FIG. 5A is a sectional view facing the ABS of the sensor and FIG. 5B is a top view of the plane of section 5B-5B of FIG. 5A. FL1 and FL2 have respective magnetization directions 251, 271 and are separated by nonmagnetic spacer layer 260. FL1 is formed on seed layer 240 on shield 51 and capping layer 280 is formed on FL2 below shield S2. FL1, nonmagnetic spacer layer 260, and FL2 are separate from exchange-coupled soft-side shields 300, 350 at the side edges 275, 276 that essentially define the sensor TW. An insulating layer 285, such as alumina (Al₂O₃), at the side edges 275, 276 electrically insulates FL1 and FL2 from the side shields 300, 350.

In the exchange-coupled side shield 300, which is identical to side shield 350, soft magnetic layers 310, 320 are separated by a nonmagnetic antiparallel-coupling (APC) layer 315, typically a 0.5-1 nm thick layer of Ru or Cr. To improve coupling, 1-2 nm thick layers of Co, Fe, or a CoFe alloy (not shown) may be located between the APC layer 315 and soft magnetic layers 310, 320, respectively. The thickness of the APC layer 315 is chosen to provide adequate antiferromagnetic exchange coupling, resulting in the magnetization directions 311, 321 of soft magnetic layers 310, 320 being oriented antiparallel.

Thus layers 310, 320 (and also layers 360, 370 in exchange-coupled soft side shield 350) are preferably an alloy comprising Ni and Fe with permeability (μ) preferably greater than 10. Any of the known materials suitable for use in the along-the-track shields S1 and S2 may be used for layers 310, 320. Specific compositions include NiFeₓ, where x is between 1 and 25, and (NiFeₓ)Mo_{y} or (NiFeₓ)Cr_{y}, where y is between 1 and 8, where the subscripts are in atomic percent.

As shown in FIGS. 5A-5B, layers 320, 370 are aligned generally vertically on the substrate (S1) with the side edges of FL2, and layers 310, 360 are aligned generally vertically on the substrate with the side edges of FL1. Thus the magnetization directions 321 of layer 320 and 371 of layer 370 provide a longitudinal magnetic bias field to the magnetization 271 of FL2. Similarly, the magnetization directions 311 of layer 310 and 361 of layer 360 provide a longitudinal magnetic bias field to the magnetization 251 of FL1. This longitudinal biasing of Fl1 and FL2 is in addition to the orthogonal biasing provided by hard bias layer 290 with magnetization direction 291. The longitudinal biasing provided by the exchange coupled soft side shields 300, 350 thus assures that the magnetization 271 of FL2 points to the left in FIG. 5B and that the magnetization 251 of FL1 points to the right in FIG. 5B. In addition to providing longitudinal biasing for FL1 and Fl2, the exchange-coupled soft side shields 300, 350 also shield the sensor free layers FL1, FL2 from recorded bits in adjacent tracks, i.e., tracks on either side of the TW region of the sensor.

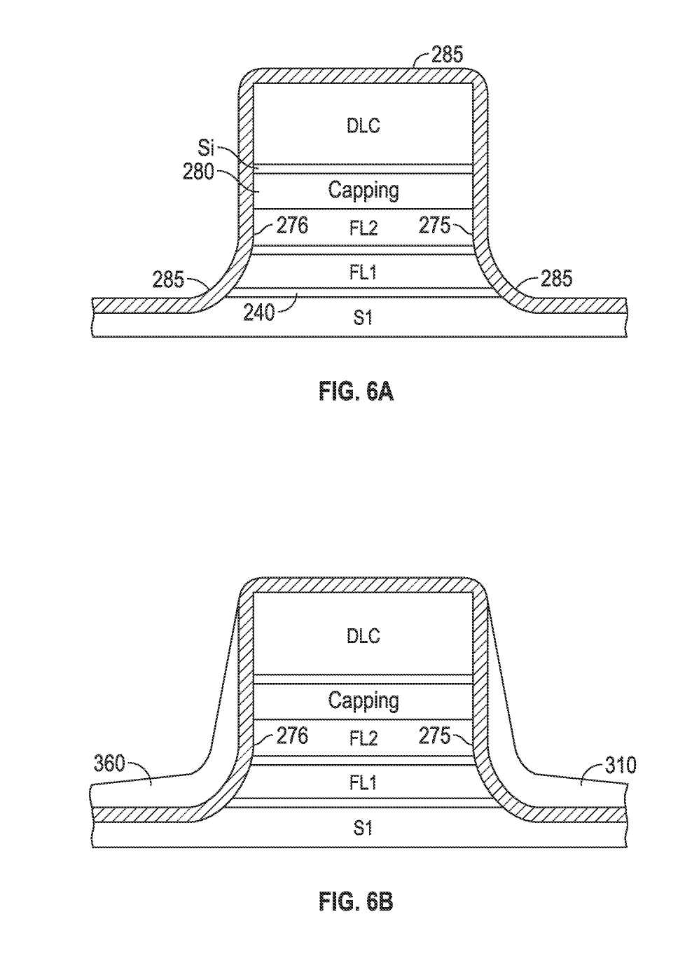

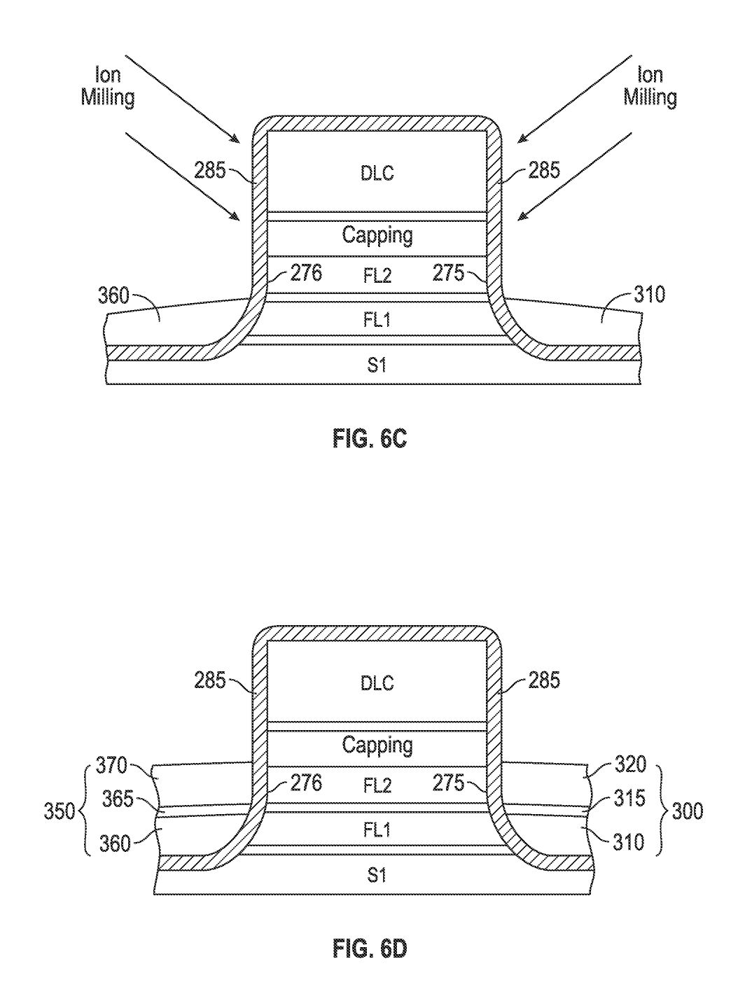

The method for forming the exchange-coupled side shields in the CPP-MR read head shown in FIGS. 5A-5B will now be described using FIGS. 6A-6D. First, all of the layers making up the sensor stack, i.e., layers from seed layer 240 up through capping layer 280, are deposited as full films on S1, typically by sputter deposition. A thin silicon (Si) film is then deposited as a full film on capping layer 280. The Si is an adhesion film for a subsequently deposited full film of hard mask material, like diamond-like carbon (DLC). A layer of photoresist is then deposited on the DLC. The photoresist is then lithographically patterned to define the two side edges 275, 276 of the sensor.

Next, as shown in FIG. 6A, an ion milling step removes the layers outside the sensor side edges 275, 276 down to S1. However, present ion milling techniques create a sloping tail at the base of the milled stack, as shown in FIG. 6A. The side regions are then refilled by deposition of the insulating layer 285, typically alumina or a silicon nitride (SiNₓ), on S1 and on the side edges 275, 276.

Next, as shown in FIG. 6B, the material for the lower soft magnetic layers 310, 360, are deposited to the desired thickness by ion beam deposition. However, the IBD also coats the insulating layer 285 up to and past the side edges 275, 276 of the nonmagnetic spacer layer 260 and FL2. If this material were to remain adjacent the side edges of FL2 when the material of APC layers 315, 365 and the material for upper soft magnetic layers 320, 370 layers was deposited, the antiparallel exchange-coupled soft side shields would not function properly. This is because the magnetization direction of this soft magnetic material adjacent to the sidewalls would be ill-defined, creating uncertainty in the biasing of FL2. It is preferable to deposit layer 310 and layer 360 by IBD rather than by sputtering since the directional nature of IBD minimizes the amount of material deposited along the edges 275, 276 of FL2. Nevertheless, due to beam dispersion in IBD tooling, it is inevitable that some material from layers 310 and 360 will coat the edges 275, 276 of the sensor stack along FL2. Thus a critical step in one of the embodiments of the method of this invention is the removal of the material of the lower soft magnetic layers from adjacent the side edge of FL2. This is achieved by oblique angle ion beam milling as shown in FIG. 6C. Oblique angle milling refers to the small angle relative to the plane of the substrate (S1). This cleans the insulating layer 285 of the soft magnetic material without significant damage to or removal of the main body of the lower soft magnetic layers 310, 360 because the sputter removal rate of these soft magnetic materials is highly angle-dependent. Therefore the ion milling is at an oblique angle, preferably between about 50 to 85 degrees relative to a normal to the substrate (S1), and is performed at a low voltage, e.g., between about 100 to 300 V). After the oblique angle ion milling the lower soft magnetic layers 310, 360 have a thickness so that they are generally aligned vertically with FL1. This cleaning of the sensor sidewalls can be accomplished without substantial removal of the insulating layer 285 because alumina (or other insulating oxides) are milled much more slowly than the soft magnetic material (e.g., NiFe).

Next, as shown in FIG. 6D, the material for APC layers 315, 365 (typically Ru or Cr) is ion beam deposited to a thickness between about 0.5-1.0 nm, followed by IBD of the material for upper soft magnetic layers 320, 370. The material for upper soft magnetic layers 320, 370 is deposited to a thickness so that layers 320, 370 will be generally aligned vertically with FL2. In some implementations, the soft magnetic material in layers 320 and 370 will be directly exchange-coupled to the upper magnetic shield S2, in which case the boundary between layers 320 and 370 and the upper shield S2 is ill-defined but not important.

As an alternative embodiment of the method, instead of IBD of the material for the lower soft magnetic layers 310, 360, this material can be deposited by electroplating. After deposition of the insulating layer 285, a thin seed layer, such as a 1 to 4 nm thick film of NiFe, can be deposited by sputter deposition or IBD, followed by cleaning of the seed layer material from the side edges using oblique angle ion milling. The material for the lower soft magnetic layers 310, 360 is then electroplated on the seed layer to the desired thickness. This is then followed by sputter deposition of the material for APC layers 315, 365 and sputter deposition or IBD of the material for the upper soft magnetic layers 320, 370.

After formation of the exchange-coupled soft side shields 300, 350, a second Si adhesion layer and second DLC layer are then deposited in the side regions over the two exchange-coupled soft side shields 300, 350. Due to the topographic selectivity of the process, the material deposited on top of the DLC above the capping layer is then removed by chemical-mechanical-polishing (CMP) assisted lift-off down to the DLC layers. The second DLC layer protects the soft bias layers 320, 370. A reactive ion etching (RIE) step then removes the DLC above the capping layer and the second DLC above the soft bias 320, 370. An ion milling step is then performed to remove the Si layers. This is followed by deposition of the top shield S2. Depending on method to stabilize the soft-bias magnetization directions 321, 371, the layers 320, 370 can be decoupled from S2 by a thin (less than 5 nm) non-magnetic spacer layer deposited on top of the soft side shields 320, 370. Alternatively, the layers 320, 370 can be directly coupled to S2 as described further below.

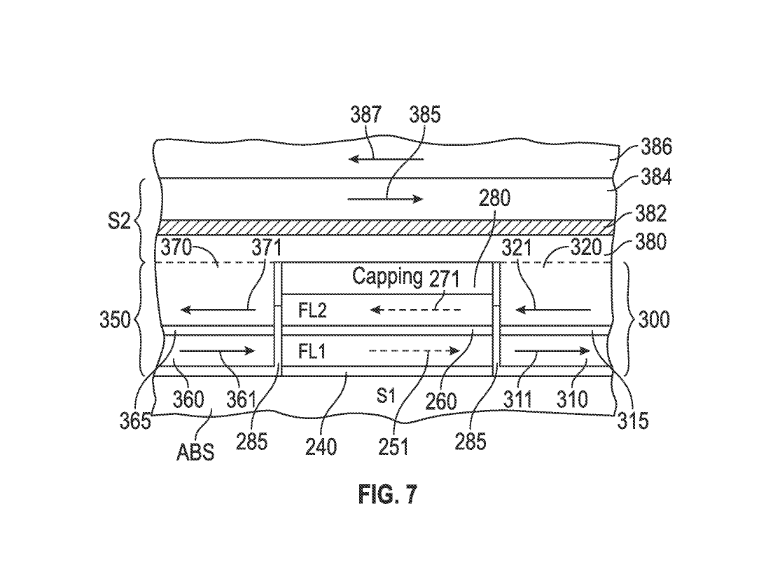

There are several ways to set the magnetization directions 321, 371 of the exchange-coupled soft side shields. One method is described with FIG. 7. First a base layer 380 of soft magnetic shield material (e.g., NiFe) approximately 30 nm thick is deposited on the soft side shield layers 320, 370 and on top the capping layer 280. The base layer 380 will serve as the base of the top shield S2 and will set the magnetization directions 321, 371 of the soft side shield layers 320, 370. Then a thin (typically between about 0.5 to 1 nm) antiferromagnetic-coupling (AFC) layer 382 (e.g., Ru) is deposited on base layer 380. AFC layer 382 will provide antiferromagnetic exchange coupling between the base layer 380 and a subsequently deposited layer 384 of soft magnetic upper shield material (e.g., NiFe) approximately 25 nm thick. Finally, an antiferromagnetic (AF) layer 386 (e.g., IrMn) is deposited on top of the upper shield layer 384. A magnetic field anneal is then performed to set the magnetization direction 387 of the AF layer 386 and the exchange pinning between the antiferromagnetic layer 386 and the upper shield layer 384. The upper shield layer 384 will thus have a magnetization direction 385, which will cause the magnetization directions 321, 371 of the soft side shield layers 320, 371 to be antiparallel to magnetization direction 385 due to antiferromagnetic exchange coupling across AFC layer 382.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

What is claimed:

1. A method for making a scissoring type current-perpendicular-to-the-plane magnetoresistive sensor, the sensor having a first free ferromagnetic layer (FL1) and a second free ferromagnetic layer (FL2) separated by a nonmagnetic spacer layer, wherein the FL1 and FL2 magnetization directions are free to rotate relative to one another in the presence of an external magnetic field to be sensed, the method comprising:
providing a substrate;
depositing FL1, the nonmagnetic spacer layer and FL2 on the substrate;
patterning FL1, the nonmagnetic spacer layer and FL2 to define spaced-apart side edges at FL1, the nonmagnetic spacer layer and FL2;
depositing a layer of insulating material on the substrate and on the side edges;
depositing a first layer of soft ferromagnetic material on the substrate and in contact with the insulating layer at the side edges of FL1, the nonmagnetic spacer layer and FL2;
performing oblique angle ion milling of the first layer of soft ferromagnetic material to remove the first layer of soft ferromagnetic material adjacent the side edges of FL2;
depositing an antiparallel coupling (APC) layer on the first layer of soft ferromagnetic material; and
depositing a second layer of soft ferromagnetic material on the APC layer and in contact with the insulating layer at the side edges of FL2.

2. The method of claim 1 wherein depositing the first layer of soft ferromagnetic material comprises depositing the first layer of soft ferromagnetic material by ion beam deposition.

3. The method of claim 1 wherein depositing the first layer of soft ferromagnetic material comprises depositing the first layer of soft ferromagnetic material by electroplating.

4. The method of claim 1 wherein performing oblique angle ion milling comprises performing said milling at an angle greater than or equal to 50 degrees and less than or equal to 85 degrees from a normal to the substrate.

5. The method of claim 1 wherein performing oblique angle ion milling comprises performing said milling at a voltage greater than or equal to 100 V degrees and less than or equal to 300 V.

6. The method of claim 1 wherein depositing a layer of insulating material on the substrate and on the side edges comprises depositing a layer of alumina.

7. The method of claim 1 wherein depositing a first layer of soft ferromagnetic material on the substrate and in contact with the insulating layer at the side edges of FL1, the nonmagnetic spacer layer and FL2 comprises depositing material selected from NiFeₓ where x is between 1 and 25, (NiFeₓ)Mo_{y} where y is between 1 and 8, and (NiFeₓ)Cr_{y} where y is between 1 and 8, where the subscripts are in atomic percent.

8. The method of claim 1 further comprising:
depositing a base layer of soft ferromagnetic material on the second layer of ferromagnetic material;
depositing an antiferromagnetic coupling (AFC) layer on the base layer;
depositing an upper layer of soft ferromagnetic material on the AFC layer;
depositing an antiferromagnetic layer (AF) on the AFC layer; and
annealing the AF layer in the presence of a magnetic field.

9. A method for making a scissoring type current-perpendicular-to-the-plane magnetoresistive sensor, the sensor having a first free ferromagnetic layer (FL1) and a second free ferromagnetic layer (FL2) separated by a nonmagnetic spacer layer, wherein the FL1 and FL2 magnetization directions are free to rotate relative to one another in the presence of an external magnetic field to be sensed, the method comprising:
providing a bottom shield S1;
depositing FL1, the nonmagnetic spacer layer and FL2 on S1;
patterning FL1, the nonmagnetic spacer layer and FL2 to define spaced-apart side edges at FL1, the nonmagnetic spacer layer and FL2;
depositing a layer of insulating material on S1 and on the side edges;
depositing, by ion beam deposition, a first layer of soft ferromagnetic material on S1 and in contact with the insulating layer at the side edges of FL1, the nonmagnetic spacer layer and FL2;
performing oblique angle ion milling of the first layer of soft ferromagnetic material to remove the first layer of soft ferromagnetic material adjacent the side edges of FL2, said ion milling being performed at an greater than or equal to 50 degrees and less than or equal to 85 degrees from a normal to S1;
depositing an antiparallel coupling (APC) layer on the first layer of soft ferromagnetic material; and
depositing a second layer of soft ferromagnetic material on the APC layer and in contact with the insulating layer at the side edges of FL2.

10. The method of claim 9 wherein performing oblique angle ion milling comprises performing said milling at a voltage greater than or equal to 100 V degrees and less than or equal to 300 V.

11. The method of claim 9 wherein depositing a layer of insulating material on S1 and on the side edges comprises depositing a layer of alumina.

12. The method of claim 9 wherein depositing a first layer of soft ferromagnetic material on S1 and in contact with the insulating layer at the side edges of FL1, the nonmagnetic spacer layer and FL2 comprises depositing material selected from NiFeₓ where x is between 1 and 25, (NiFeₓ)Mo_{y} where y is between 1 and 8, and (NiFeₓ)Cr_{y} where y is between 1 and 8, where the subscripts are in atomic percent.
